(19) United States
(12) Patent Application Publication
(10) Pub. No.: US 2011/0096469 A1
(43) Pub. Date: Apr. 28, 2011

(54) HVAC CONNECTION ADAPTOR

(76) Inventor: Melvin Lee Atkins, Houston, TX (US)

(21) Appl. No.: 12/604,200

(22) Filed: Oct. 22, 2009

(51) Int. Cl. H02B 1/32

(52) U.S. Cl. 361/622

(57) ABSTRACT

An adapter to maintain power may include a first switch to connect the power to a building, a first relay to cooperate with the first switch; a second switch to connect the power to the building, and a second relay to cooperate with the second switch. The building may include a high-voltage air conditioning system (HVAC), and the first relay may be spring and solenoid operated. The second relay may be spring and solenoid operated, and the adapter may include a closable housing. The first switch may switch between building power and a generator, and a second switch may switch between building power and the generator.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

1. Field of the Invention

This invention relates in general to generators used to provide power to residential or commercial heating, ventilation air conditioning (HVAC) systems, and more particularly to an adaptor that allows quick connection of a residential or commercial heating, ventilation air conditioning (HVAC) system to a commercially available electrical generator as well as a circuit control system to allow for simple operation.

Presently practiced HVAC systems are directly connected electrically to a circuit breaker of the building (as used herein, building means and includes comparable commercial installations) electric system. Stated another way, presently practiced HVAC systems do not have plug-in connections, but are hard-wired to the breaker. In the event of a power outage due to storm or otherwise, buildings are without any means of circulating air in the building. Due to the hard-wired nature of the electrical supply, the HVAC system cannot be plugged into a commercially available breaker.

2. Description of the Related Art

Presently, electrical power to HVAC systems in residential and commercial installations comprises hard-wired circuits between the circuit breaker box and the HVAC system. To switch to an emergency power source, such systems require a skilled professional to disconnect the wiring and to attach it in a safe manner to the emergency power source. The lack of a plug-in connection to an emergency power source in the prior art demonstrates the desirability of providing an adaptor for quick and direct connections between HVAC systems and commercially available electrical generators.

### BRIEF SUMMARY OF THE INVENTION

Accordingly, it is an object of the present invention to provide a device that allows commercially available electrical generators to be quickly connected to residential or commercial heating, ventilation air conditioning (HYAC) systems as well as a circuit control system to allow for simple operation. The present invention teaches the use of such a device.

An adapter to maintain power may include a first switch to connect the power to a building, A first relay to cooperate with the first switch; a second switch to connect the power to the building, and a second relay to cooperate with the second switch.

The building may include a high-voltage air conditioning system (HVAC), and the first relay may be spring and solenoid operated.

The second relay may be spring and solenoid operated, and the adapter may include a closable housing.

The first switch may switch between building power and a generator, and a second switch may switch between building power and the generator.

The first relay may operate on 24 V, and the second relay may operate on 24 V.

The first relay may operate on 120 V, and a second relay may operate on 120V.

### BRIEF DESCRIPTION OF THE DRAWINGS

For a more complete understanding of the present invention and the advantages thereof, reference is now made to the following Detailed Description of an Example Embodiment of the Invention, taken in conjunction with the accompanying drawings, in which:

FIG. 1 depicts an embodiment of the present invention as installed.

FIG. 2 depicts an embodiment of the present invention.

FIG. 3 depicts an alternate embodiment of the present invention as installed.

FIG. 4 depicts an alternate embodiment of the invention.

FIG. 5 depicts an alternate embodiment of the invention.

FIG. 6 depicts a method of installation of the present invention.

### DESCRIPTION OF THE INVENTION

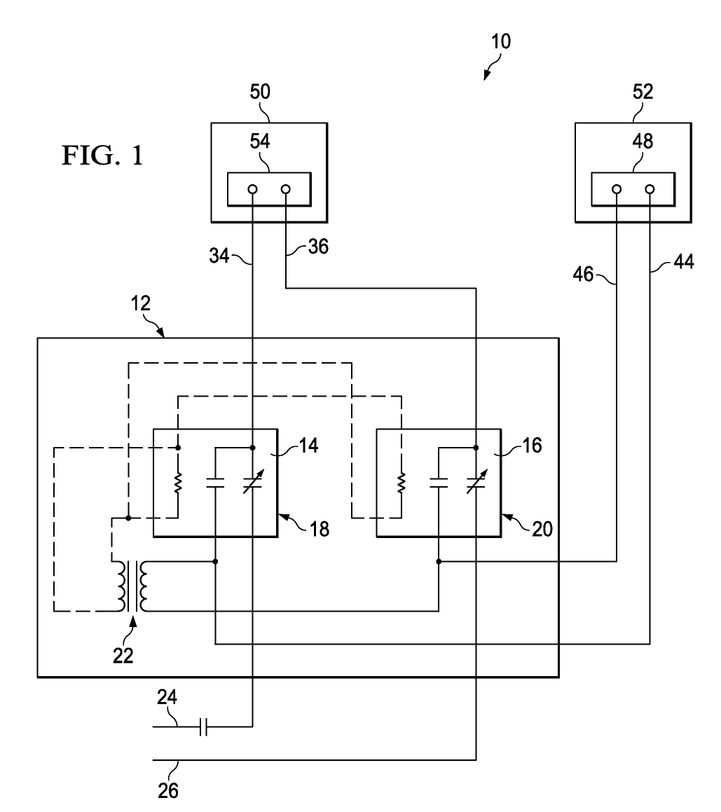

Referring to FIG. 1, a preferred embodiment of the invention, adaptor 10 comprises a housing 12 containing a first switch 14, a second switch 16, a first relay 18, a second relay 20 and a transformer 22. The relays 18 and 20 along with the switches 14 and 16 may be composed of two physically separate relay and switch devices or may be composed of a physically integrated double relay and switch device. In the embodiments shown in FIGS. 1 through 3, 24-volt relays are used. However, 120-volt relays may be used as well as is described in an alternate embodiment below.

By way of appropriate connectors, first switch 14 is connected to building wire 24 and is further connected to adaptor lead wire 34. Second switch 16 is connected to building wire 26 and is further connected to adaptor lead wire 36. First switch 14 is further connected to plug wire 44. Second switch 16 is further connected to plug wire 46.

Building wires 24 and 26 connect at the opposite ends to a standard building power source. Building wires 24 and 26 are standard building wires used in various commercial, residential, and industrial buildings, as well as other structures. In the prior art building wires 24 and 26 would connect directly to an HVAC system 50.

In the exemplary embodiment shown in FIG. 1, relay 18 is electrically connected to transformer 22. Transformer 22 is in turn electrically connected to plug wires 44 and 46. Switch 14 is operable by relay 18. In like manner switch 16 is operable by relay 20. Relay 20 is electrically connected to transformer 22.

Plug wires 44 and 46 are connected at their ends distal from switches 14 and 16 to a standard, commercially available electrical plug 48. Electrical plug 48 is of a type useable for connection to a standard, commercially available electrical generator 52, including, for instance, a portable gasoline-powered generator.

Adaptor lead wires 34 and 36 are connectable to an HVAC power connector 54 of a standard commercially available HVAC system 50.

Switches 14 and 16 are each double pole switches. Through appropriate connectors, switch 14 is connectable to building wire 24, lead wire 34 and plug wire 44. Relay 18 and switch 14 are operable to connect lead wire 34 to either building wire 24 or plug wire 44. Relay 20 and switch 16 are operable to connect lead wire 36 with either building wire 26 or plug wire 46.

In the embodiment depicted in FIG. 1, switch 14 is shown connected to building wire 24 and switch 16 is shown connected to building wire 26.

In an exemplary embodiment, relays 18 and 20 are spring and solenoid-Operated. By way of example, a spring (not shown) normally biases an electrically-conductive switch lever (not shown) of switch 14 to an electrical connection with plug wire 44. When no power is provided to switch 14 through building wire 24, a solenoid (not shown) provides sufficient force to overcome the spring bias and push the switch lever of switch 14 to an electrical connection with plug wire 44. Accordingly, when building power is on, switch 14 electrically connects building wire 24 to lead wire 34. When building power is off, switch 14 electrically connects plug wire 44 to lead wire 34. In like manner, a spring (not shown) normally biases an electrically-conductive switch lever (not shown) of switch 16 to an electrical connection with plug wire 46. When no power is provided to switch 16 by way of building wire 26, a solenoid (not shown) provides sufficient force to overcome the spring bias and push the switch lever of switch 16 to an electrical connection with plug wire 46. Accordingly, when building power is on, switch 16 electrically connects building wire 26 to lead wire 36. When building power is off, switch 16 electrically connects plug wire 46 to lead wire 36.

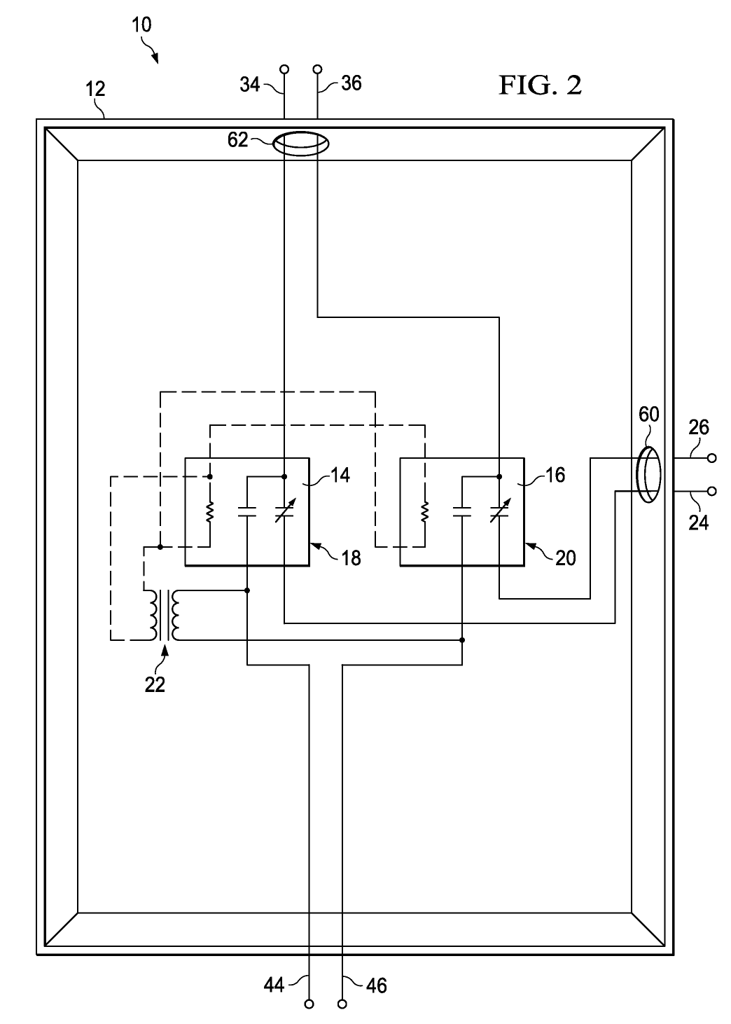

Referring to FIG. 2, in an exemplary embodiment, housing 12 is a closeable container. Transformer 22, relays 18 and 20, and switches 14 and 16 are contained within housing 12. Plug lines 44 and 46 are connected to switches 14 and 16 respectively and extend through housing 12 to plug 48 (not shown in FIG. 2). Opening 60 is provided in housing 12 to allow building wire lines 24 and 26 to be inserted there through for connection to switches 14 and 16, Opening 62 is provided in housing 12 to allow lead wires 34 and 36 to extend there through for connection with switches 14 and 16.

In operation, electrical power to the HVAC system 50 is normally provided through the building power lines 24 and 26. When power is available to switch 14 through building wire 24, relay 18 biases switch 14 to connect building wire with lead wire 34. Thus, relay 18 operates to maintain switch 14 at a setting wherein switch 14 electrically connects building wire 24 to lead wire 34. When no power is available to switch 16, relay 20 biases switch 16 to connect building wire 26 with lead wire 36. Thus, relay 20 operates to maintain switch 16 at a setting wherein switch 16 electrically connects building wire 26 to lead wire 36. In such configuration, power to the HVAC system 50 is provided from the building power source.

Upon interruption of building power, electric power to lines 24 and 26 is interrupted. With no power available through lines 24 and 26, power is not available to switches 14 and 16, and relays 18 and 20. In the event of power interruption to relay 18, the relay will no longer be actively oriented to bias switch 14 to building wire 24. The switch will then, without power, be biased to operate switch 14 to electrically connect plug wire 44 to lead wire 34. Relay 20 operates switch 16 in a similar manner to electrically connect plug wire 46 to lead wire 36.

Accordingly, plug 48 may be connected to a generator 52 to provide power to the HVAC system 50.

Accordingly, switches 14 and 16 will be biased to connect lead wire 34 with plug wire 44 and lead wire 36 with plug wire 46 until building power is restored. Upon restoration of building power, switches 14 and 16 will again be powered by means of building lines 24 and 26, allowing the solenoids of relays 18 and 20 to again bias switches 14 and 16 to provide electrical connection of building power line 24 to lead wire 34 and building power line 26 to lead wire 36.

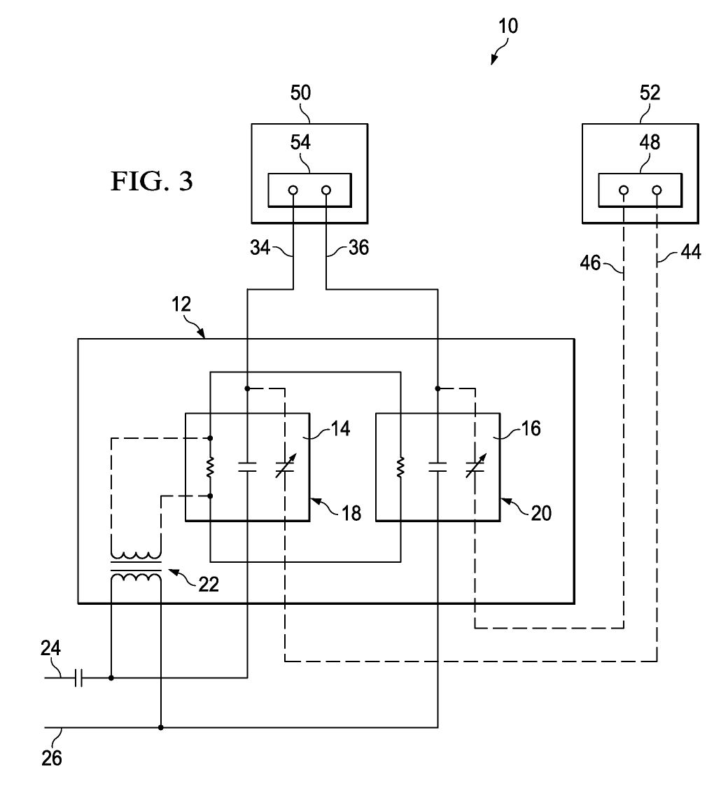

FIG. 3 depicts an alternate embodiment of the invention. In this alternate embodiment building lines 24 and 26 are electrically connected to transformer 22 rather than plug lines 44 and 46 being connected to transformer 22. Switch 14 is connected to plug wire 44 and is further connected to adaptor lead wire 34. Second switch 16 is connected to plug wire 46 and is further connected to adaptor lead wire 36. Switch 14 is further connected to building wire 24. Switch 16 is further connected to building wire 26.

In the alternate embodiment shown in FIG. 3, relays 18 and 20 are electrically connected to transformer 22. Transformer 22 is in turn electrically connected to building wires 24 and 26. Switch 14 is operable by relay 18. In like manner switch 16 is operable by relay 20.

In this alternate embodiment when power is provided to transformer 22 by way of building wires 24 and 26, relay 18 operates to push the switch lever of switch 14 to an electrical connection between building wires 24 and 26 and lead wires 34 and 36 respectively. When power is provided to transformer 22 by way of building wire 24, a solenoid (not shown) provides sufficient force to overcome the spring bias and push the switch lever of switch 14 to an electrical connection with building wire 24. Accordingly, when building power is on, switch 14 electrically connects building wire 24 to lead wire 34. When building power is off, switch 14 electrically connects plug wire 44 to lead wire 34. In like manner, relay 20 operates switch 16 to an electrical connection with plug wire 46. When power is provided to transformer 22 by way of building wire 26, a solenoid (not shown) provides sufficient force to overcome the spring bias and push the switch lever of switch 16 to an electrical connection with building wire 26. Accordingly, when building power is off, switch 16 electrically connects plug wire 46 to lead wire 36.

While a transformer 22 is depicted in the exemplary embodiment, one skilled in the art would recognize that relays 18 and 20 could be powered from the building wires 24 and 26 or the plug wires 44 and 46 without voltage transformation by utilizing relays configured to operate on building voltage. In an alternate embodiment of the invention a 120-volt relay is used rather than a 24-volt relay. By using a 120-volt relay rather than a 24-volt relay the necessity for a transformer is removed.

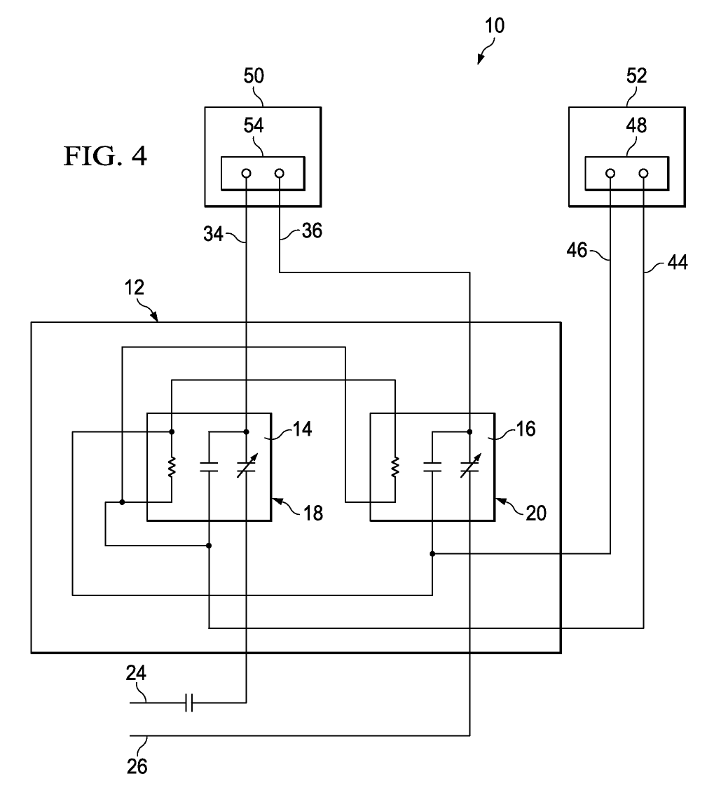

FIG. 4 depicts this alternate embodiment of the invention. The building wires 24 and 26 are directly electrically connected to switches 14 and 16 respectively. In a like manner, plug wires 44 and 46 are directly electrically connected to switches 14 and 16.

Switches 14 and 16 are further connected to lead wires 34 and 36. Plug wires 44 and 46 are electrically connected to relays 18 and 20. Switch 14 is operable by relay 18. In like manner, switch 16 is operable by relay 20.

In this alternate embodiment, when power is not provided to relays 18 and 20 by way of plug wires 44 and 46, relays 18 and 20 operate to push the switch lever of switches 14 and 16 to an electrical connection between building wires 24 and 26 and lead wires 34 and 36 respectively. To further explain, when power is provided to relay 18 by way of plug wire 44, a solenoid (not shown) provides sufficient force to overcome the spring bias and push the switch lever of switch 14 to an electrical connection with plug wire 44. Accordingly, when the generator 52 power is on, switch 14 electrically connects plug wire 44 to lead wire 34. When generator 52 power is off; switch 14 electrically connects building wire 24 to lead wire 34. In like manner, relay 20 operates switch 16 to an electrical connection with either building wire 26 or plug wire 46. When generator 52 power is provided to relay 20 by way of plug wire 46, a solenoid (not shown) provides sufficient force to overcome the spring bias and push the switch lever of switch 16 to an electrical connection with plug wire 46. Accordingly, when generator power is on, switch 16 electrically connects plug wire 46 to lead wire 36.

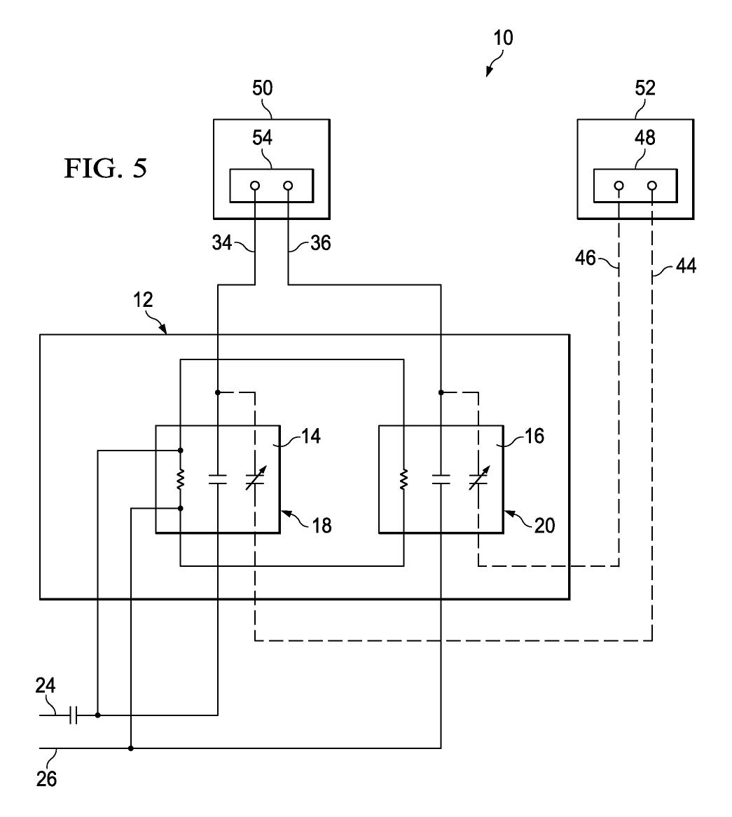

In another alternate embodiment of the invention, depicted in FIG. 5, using a relay 120-volt relay rather than a 24-volt relay, both building wires 24 and 26 as well as both plug wires 44 and 46 are directly connected to switches 14 and 16 respectively. Building wires 24 and 26 may be electrically connected to the relays 18 and 20.

FIG. 5 depicts this alternate embodiment of the invention. The building wires 24 and 26 are directly electrically connected to switches 14 and 16 respectively. In a like manner, plug wires 44 and 46 are directly electrically connected to switches 14 and 16.

Switches 14 and 16 are further connected to lead wires 34 and 36. Building wires 24 and 26 are electrically connected to relays 18 and 20. Switch 14 is operable by relay 18. In like manner, switch 16 is operable by relay 20.

In this alternate embodiment, when power is provided to relays 18 and 20 by way of building wires 24 and 26, relays 18 and 20 operate to push the switch lever of switches 14 and 16 to an electrical connection between building wires 24 and 26 and lead wires 34 and 36 respectively. To further explain, when power is provided to relays 18 by way of building wire 24, a solenoid (not shown) provides sufficient force to overcome the spring bias and push the switch lever of switch 14 to an electrical connection with building wire 24. Accordingly, when building power is on, switch 14 electrically connects building wire 24 to lead wire 34. When building power is off, switch 14 electrically connects plug wire 44 to lead wire 34, In like manner, relay 20 operates switch 16 to an electrical connection with either building wire 26 or plug wire 46. When power is provided to relay 20 by way of building wire 26, a solenoid (not shown) provides sufficient force to overcome the spring bias and push the switch lever of switch 16 to an electrical connection with building wire 26. Accordingly, when building power is off, switch 16 electrically connects plug wire 46 to lead wire 36.

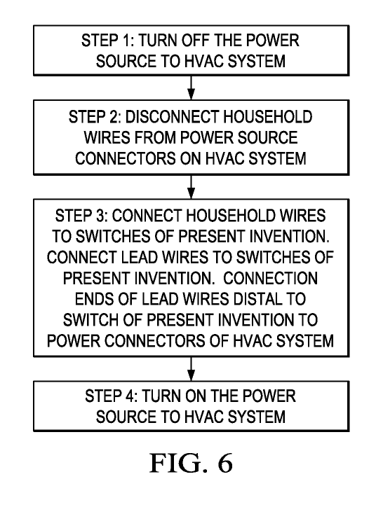

The invention includes a method of installation of adaptor 10 as depicted in FIG. 6. The method includes: (1) a preparation step, (2) a disconnection step, (3) a connection step, and (4) a source power step. The preparation step consists of turning off the source power to the HVAC system 50. The disconnection step consists of disconnecting the building wires 24 and 26 from the HVAC power connector 54. The connection step consists of connecting building wires 24 and 26 to switches 14 and 16 respectively. Opposite to building wires 24 and 26, lead wires 34 and 36 are then connected to switches 14 and 16 respectively. The opposite ends of lead wires 34 and 36 are then connected to HVAC system 50 at HVAC power connector 54. The source power step consists of turning on the source power to the HVAC system 50.

Although various exemplary embodiments have been shown and described, the invention is not limited to the embodiments shown. No single embodiment is representative of all aspects of the present invention.

1) An adapter to maintain power, comprising:
a first switch to connect the power to a building;
a first relay to cooperate with the first switch;
a second switch to connect the power to the building;
a second relay to cooperate with the second switch.

2) An adapter to maintain power as in claim 1, wherein the building includes a high-voltage air conditioning system (HVAC).

3) An adapter to maintain power as in claim 1, wherein the first relay is spring and solenoid operated.

4) An adapter to maintain power as in claim 1, wherein the second relay is spring and solenoid operated.

5) An adapter to maintain power as in claim 1, wherein the adapter includes a closable housing.

6. An adapter to maintain power as in claim 1, wherein the first switch switches between building power and a generator.

7) An adapter to maintain power as in claim 1, wherein the second switch switches between building power and the generator.

8) An adapter to maintain power as in claim 1, wherein the first relay operates on 24 V.

9) An adapter to maintain power as in claim 1, wherein the second relay operates on 24 V.

10) An adapter to maintain power as in claim 1, wherein the first relay operates on 120 V.

11) An adapter to maintain power as in claim 1, wherein the second relay operates on 120 V.
